(19) United States
(12) Patent Application Publication
(10) Pub. No.: US 2023/0063266 A1
(43) Pub. Date: Mar. 2, 2023

(54) PIXEL DRIVING CIRCUIT, DISPLAY SCREEN, AND TERMINAL

(71) Applicant: Guangdong Oppo Mobile Telecommunications Corp., Ltd., Dongguan (CN)

(72) Inventors: Chenglei NIE, Dongguan (CN); Zhijia CUI, Dongguan (CN)

(21) Appl. No.: 18/048,250

(22) Filed: Oct. 20, 2022

Related U.S. Application Data
(63) Continuation of application No. PCT/CN2021/078454, filed on Mar. 1, 2021.

(30) Foreign Application Priority Data
Apr. 20, 2020 (CN) 202010310026.1

(51) Int. Cl. G09G 3/3258; G09G 3/3291

(52) U.S. Cl. CPC G09G 3/3258; G09G 3/3291; G09G 2300/0842; G09G 2310/061; G09G 2310/08

(57) ABSTRACT

Provided are a pixel driving circuit, a display screen, and a terminal. The pixel driving circuit includes: a data writing path, a light-emitting path, a reset path, and a capacitor. An end of the data writing path is configured to receive to a data voltage, another end of the data writing path is connected to a first node; an end of the light-emitting path is configured to receive a positive voltage of a power supply, and another end of the light-emitting path is configured to receive a negative voltage of the power supply. The reset path includes a first transistor and a second transistor. An end of the capacitor is connected to the positive voltage of the power supply, and another end of the capacitor is connected to the first node.

### CROSS REFERENCE

The present application is a continuation of International Patent Application No. PCT/CN2021/078454, filed Mar. 1, 2021, which claims priority to Chinese Patent Application No. 202010310026.1, filed Apr. 20, 2020, the entire disclosures of which are incorporated herein by reference.

### TECHNICAL FIELD

The present disclosure relates to the field of terminal technologies, and in particular to a pixel driving circuit, a display screen, and a terminal.

### BACKGROUND

Conventionally, a light-emitting circuit includes an active-matrix organic light-emitting diode (AMOLED) panel. The AMOLED is also known as a source-matrix organic light-emitting diode or an active-matrix organic light-emitting diode, which has self-emitting properties and includes an organic material coating and a glass substrate. The AMOLED is driven by a driving current to emit light. The organic material in an organic material layer of the AMOLED emits light when a current passes through. Thin film transistor (TFT) is usually applied as the driver of AMOLED, and low temperature poly-silicon (LTPS) is a common TFT technology. Therefore, LTPS is often applied as the driver in terminal products adopting AMOLED as display screens, thereby realizing the process of displaying images.

### SUMMARY OF THE DISCLOSURE

The present disclosure provides a pixel driving circuit, a display screen, and a terminal to reduce the difficulty of fine-tuning the correction parameters.

In an aspect, the present disclosure provides a pixel driving circuit, including: a data writing path, a light-emitting path, a reset path and a capacitor; wherein an end of the data writing path is configured to receive a data voltage, another end of the data writing path is connected to a first node; an end of the light-emitting path is configured to receive a positive voltage of a power supply, and another end of the light-emitting path is configured to receive a negative voltage of the power supply; the reset path comprises a first transistor and a second transistor, a first end of the first transistor being connected to a second node, a second end of the first transistor being configured to receive a reset voltage, a first end of the second transistor being connected to the first node, and a second end of the second transistor being connected to the second node; an end of the capacitor is connected to the positive voltage of the power supply, and another end of the capacitor is connected to the first node; the data writing path is controlled by a first gating signal, the light-emitting path is controlled by a second gating signal, and the reset path is controlled by a third gating signal, such that the pixel driving circuit is controlled to be selectively in a resetting phase, a light-emitting phase, or a data writing phase.

In another aspect, the present disclosure provides a display screen including the pixel driving circuit in the embodiments of the present disclosure.

In a further aspect, the present disclosure provides a terminal including the display screen in the embodiments of the present disclosure.

### BRIEF DESCRIPTION OF THE DRAWINGS

FIG. 1 is a structural schematic view of a terminal according to an embodiment of the present disclosure.

FIG. 2 is a structural schematic view of a pixel driving circuit according to an embodiment of the present disclosure.

FIG. 3 is a structural schematic view of a pixel driving circuit according to another embodiment of the present disclosure.

FIG. 4 is a structural schematic view of a pixel driving circuit according to further another embodiment of the present disclosure.

FIG. 5 is a schematic view of a change in gating signals according to an embodiment of the present disclosure.

FIG. 6 is a structural schematic view of a pixel driving circuit according to further another embodiment of the present disclosure.

FIG. 7 is a structural schematic view of a pixel driving circuit according to further another embodiment of the present disclosure.

FIG. 8 is a structural schematic view of a pixel driving circuit according to further another embodiment of the present disclosure.

FIG. 9 is an equivalent circuit diagram of a leakage path according to an embodiment of the present disclosure.

### DETAILED DESCRIPTION

In order to make the objectives, technical solutions, and advantages of the present disclosure clearer, the implementations of the present disclosure will be further described in detail below in conjunction with the accompanying drawings.

The term “plurality” mentioned herein indicates two or more. The term “and/or” describes an association relationship of associated object, indicating that there may be three types of relationships. For example, A and/or B may indicate the following three cases: A alone, A and B at the same time, and B alone. The character “I” generally indicates that the associated objects before and after “I” are is in an “or” relationship.

In the embodiments of the present disclosure, the following technical solutions are provided.

A pixel driving circuit, including: a data writing path, a light-emitting path, a reset path and a capacitor; wherein an end of the data writing path is configured to receive a data voltage, another end of the data writing path is connected to a first node; an end of the light-emitting path is configured to receive a positive voltage of a power supply, and another end of the light-emitting path is configured to receive a negative voltage of the power supply; the reset path comprises a first transistor and a second transistor, a first end of the first transistor being connected to a second node, a second end of the first transistor being configured to receive a reset voltage, a first end of the second transistor being connected to the first node, and a second end of the second transistor being connected to the second node; an end of the capacitor is connected to the positive voltage of the power supply, and another end of the capacitor is connected to the first node; the data writing path is controlled by a first gating signal, the light-emitting path is controlled by a second gating signal, and the reset path is controlled by a third gating signal, such that the pixel driving circuit is controlled to be selectively in a resetting phase, a light-emitting phase, or a data writing phase.

In some embodiments, the data writing path comprises a third transistor, a fourth transistor, and a fifth transistor; a gate of the third transistor is configured to receive the first gating signal, a first end of the third transistor is configured to receive the data voltage, and a second end of the third transistor is connected to a third node; a gate of the fourth transistor is configured to receive the first gating signal, a first end of the fourth transistor is connected to a fourth node, and a second end of the fourth transistor is connected to the first node; a gate of the fifth transistor is connected to the first node, a first end of the fifth transistor is connected to the third node, and a second end of the fifth transistor is connected to the fourth node.

In other embodiments, the light-emitting path comprises a sixth transistor, a seventh transistor, a fifth transistor, and a light-emitting diode; a gate of the sixth transistor is configured to receive the second gating signal, a first end of the sixth transistor is configured to receive the positive voltage of the power supply, and a second end of the sixth transistor is connected to the third node; a gate of the seventh transistor is configured to receive the second gating signal, a first end of the seventh transistor is connected to the fourth node, and a second end of the seventh transistor is connected to the second node; a positive terminal of the light-emitting diode is connected to the second node, and a negative terminal of the light-emitting diode is configured to receive the negative voltage of the power supply; a gate of the fifth transistor is connected to the first node, a first end of the fifth transistor is connected to the third node, and a second end of the fifth transistor is connected to the fourth node.

In other embodiments, a gate of the first transistor and a gate of the second transistor are both configured to receive the third gating signal.

In other embodiments, in response to the pixel driving circuit being in the resetting phase, the first gating signal controls the data writing path to be disconnected, the second gating signal controls the light-emitting path to be disconnected, and the third gating signal controls the reset path to be turned on.

In other embodiments, in response to the pixel driving circuit being in the data writing phase, the third gating signal controls the reset path to be disconnected, the second gating signal controls the light-emitting path to be disconnected, and the first gating signal controls the data writing path to be turned on.

In other embodiments, in response to the pixel driving circuit being in the light-emitting phase, the third gating signal controls the reset path to be disconnected, the first gating signal controls the data writing path to be disconnected, and the second gating signal controls the light-emitting path to be turned on.

In other embodiments, in the resetting phase, the first gating signal is at a high level, the second gating signal is at a high level, and the third gating signal is at a low level;

the reset voltage is received through the reset path, and the first node and the second node are voltage reset.

In other embodiments, in the data writing phase, the first gating signal is at a low level, the second gating signal is at a high level, and the third gating signal is at a high level; the data voltage is received through the data writing path, and data is written to the first node.

In other embodiments, in the light-emitting phase, the first gating signal is at a high level, the second gating signal is at a low level, and the third gating signal is at a high level; the fifth transistor is controlled by the data voltage to be turned on, and the light-emitting diode is controlled by the positive voltage of the power supply to emit light.

In other embodiments, the second transistor is a dual-gated transistor.

In other embodiments, the pixel driving circuit further includes a gating signal driver; wherein the gating signal driver is connected to a gate of the first transistor and a gate of the second transistor; the gating signal driver is configured to send the third gating signal to the first transistor and the second transistor to control the first transistor and the second transistor to be disconnected or turned on.

In other embodiments, the pixel driving circuit further includes a timing controller; wherein the timing controller is connected to the gating signal driver; the timing controller is configured to control a signal output of the gating signal driver.

In other embodiments, the reset voltage is of any voltage value among −3V, −5V, or −12V.

In other embodiments, during the resetting phase, data writing phase and light-emitting phase occurring cyclically, a completion of the resetting phase comprises: a duration of the resetting phase reaching a first preset duration; or, a voltage of the first node reaching a first preset voltage value.

In other embodiments, the first transistor and the second transistor are of at least one type of: a low temperature polysilicon thin film transistor, an oxide semiconductor thin film transistor, or an amorphous silicon thin film transistor.

In other embodiments, the pixel driving circuit further includes a power supply voltage generator; wherein an interface of the power supply voltage generator is connected to an end of the light-emitting path, and another interface of the power supply voltage generator is connected to another end of the light-emitting path, for sending the positive voltage to the end of the light-emitting path and the negative voltage to the another end of the light-emitting path.

In other embodiments, a leakage path of the pixel drive circuit is a path including the first node, the second transistor, and the first transistor.

The present disclosure further provides a display screen, and the display screen includes the pixel driving circuit described in the embodiments of the present disclosure.

The present disclosure further provides a terminal, and the terminal includes the display screen described in the embodiment of the present disclosure.

In the embodiments of the present disclosure, the data writing path is controlled by the first gating signal, the light-emitting path is controlled by the second gating signal, and the reset path is controlled by the third gating signal to realize the data writing, light emitting and resetting of the pixel driving circuit, thereby completing the light-emitting process of the pixel driving circuit, the first end of the first transistor is connected to the second node, the second end of the first transistor is connected to the reset voltage, and the first transistor and the second transistor are controlled to be disconnected or turned on through the third gating signal, which makes the pixel driving circuit include the first transistor and the second transistor in the main leakage path, such that the leakage current during the leakage process is the current where the voltage passes through the first transistor and the second transistor, thereby reducing the leakage current of the main leakage path. In this way, the difference of the leakage current at different frequencies is reduced, thereby reducing the difficulty of fine-tuning the correction parameters.

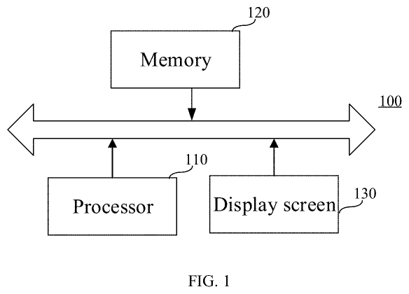

Referring to FIG. 1, FIG. 1 is a structural schematic view of a terminal 100 according to an embodiment of the present disclosure. The terminal 100 may be a smart phone, a tablet computer, a notebook computer, a wearable device, etc. The terminal 100 in the present disclosure may include one or more of the following components: a processor 110, a memory 120, and a display screen 130.

The processor 110 may include one or more processing cores. The processor 110 connects various parts within the terminal 100 through various interfaces and lines, for performing various functions of the terminal 100 and processing data by running or executing at least one instruction stored in the memory 120, and by calling data stored in the memory 120. In some embodiments, the processor 110 may be implemented with at least one of the following hardware forms: a digital signal processing (DSP), a field-programmable gate array (FPGA), a programmable logic array (PLA). The processor 110 may integrate one or a combination of some of a central processing unit (CPU), a graphics processing unit (GPU), a neural-network processing unit (NPU), and a modem. The CPU mainly handles an operating system, user interface, applications, etc.; the GPU is responsible for rendering and drawing the content to be displayed on the display screen 130; the NPU is configured to implement artificial intelligence (AI) functions; and the modem is configured to handle wireless communications. It can be understood that the modem may be implemented without being integrated into the processor 110 and through a separate chip.

The memory 120 may include random access memory (RAM) and read-only memory (ROM). In some embodiments, the memory 120 includes a non-transitory computer-readable storage medium. The memory 120 may be configured to store at least one instruction. The memory 120 may include a memory program area and a memory data area. The memory program area may store instructions for implementing the operating system, instructions for at least one function (e.g., touch function, sound playback function, image playback function, etc.), instructions for implementing each of the following embodiments, etc. The memory data area may store data created according to the use of the terminal 100 (e.g., audio data, phone book), etc.

The display screen 130 is a display component for displaying a user interface. In some embodiments, the display screen 130 is a display screen with a touch function. Through the touch function, the user may use any suitable object such as a finger or a touch pen to perform a touch operation on the display screen 130.

In some embodiments, the display screen 130 includes a pixel driving circuit disclosed in the present disclosure.

The display screen 130 is usually arranged on a front panel of the terminal 100. The display screen 130 may be designed as a full screen, a curved screen, a special-shaped screen, a double-sided screen, or a foldable screen. The display screen 130 may also be designed as a combination of a full screen and a curved screen, a combination of a special-shaped screen and a curved screen, etc., which is not limited in the embodiments.

In addition, those skilled in the art can understand that the structure of the terminal 100 shown in the attached drawing above does not constitute a limitation of the terminal 100, and the terminal 100 may include more or fewer components than shown, or a combination of certain components, or a different arrangement of components. For example, the terminal 100 further includes a microphone, a speaker, an RF circuit, an input unit, a sensor, an audio circuit, a Wireless Fidelity (Wi-Fi) module, a power supply, a Bluetooth module, and other components, which will not be described herein.

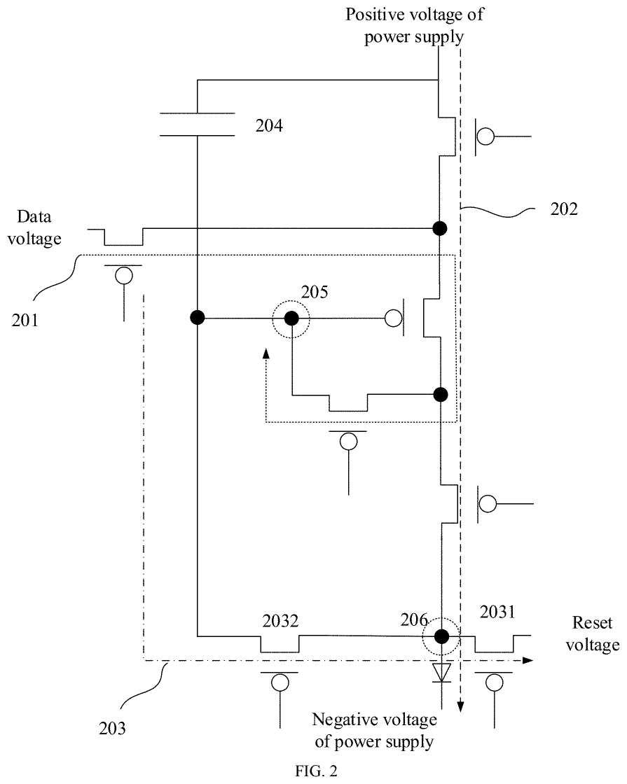

An emerging technology, adaptive dynamic frame rate (ADFR), can effectively reduce the power consumption and delay of AMOLED. However, a TFT leakage current of a LTPS AMOLED product is large, and the degree of leakage varies at different flat rates, resulting in a large difference in leakage at different frequencies, which in turn leads to high difficulty in fine-tuning correction parameters. In order to reduce the difficulty of fine tuning of the correction parameters, the present disclosure provides a pixel driving circuit. Referring to FIG. 2, the present application provides a pixel driving circuit, which may be applied in an AMOLED light-emitting circuit. The pixel driving circuit is a pixel driving circuit of 7T1C structure, including: a data writing path 201, a light-emitting path 202, a reset path 203, and a capacitor 204.

An end of the data writing path 201 is connected to a data voltage, another end of the data writing path 201 is connected to a first node 205; an end of the light-emitting path 202 is connected to a positive voltage of a power supply, and another end of the light-emitting path 202 is connected to a negative voltage of the power supply; the reset path 203 includes a first transistor 2031 and a second transistor 2032, a first end of the first transistor 2031 being connected to a second node 206, a second end of the first transistor 2031 being connected to a reset voltage, a first end of the second transistor 2032 being connected to the first node 205, and a second end of the second transistor 2032 being connected to the second node 206; an end of the capacitor 204 is connected to the positive voltage of the power supply, and another end of the capacitor 204 is connected to the first node 205; the data writing path 201 is controlled by a first gating signal, the light-emitting path 202 is controlled by a second gating signal, and the reset path 203 is controlled by a third gating signal. Gates of the first transistor 2031 and the second transistor 2032 are both connected to the third gating signal to control the pixel driving circuit to be in a resetting phase, a light-emitting phase, or a data writing phase, so as to achieve light emitting.

The pixel driving circuit cyclically goes through the resetting phase, the data writing phase, and the light-emitting phase to achieve light emission. At different phases, conduction states of the data writing path 201, the light-emitting path 202, and the reset path 203 are different, and the conduction state of the data writing path 201 is controlled by the first gating signal, the conduction state of the light-emitting path 202 is controlled by the second gating signal, and the conduction state of the reset path 203 is controlled by the third gating signal.

The end of the data writing path 201 is connected to a data driver for receiving the data voltage. An end of the light-emitting path 202 is connected to a power supply voltage generator for receiving the positive voltage of the power supply. The other end of the light-emitting path 202 is connected to the power supply voltage generator for receiving the negative voltage of the power supply. The second end of the second transistor 2032 is connected to an input end of the reset voltage for receiving the reset voltage.

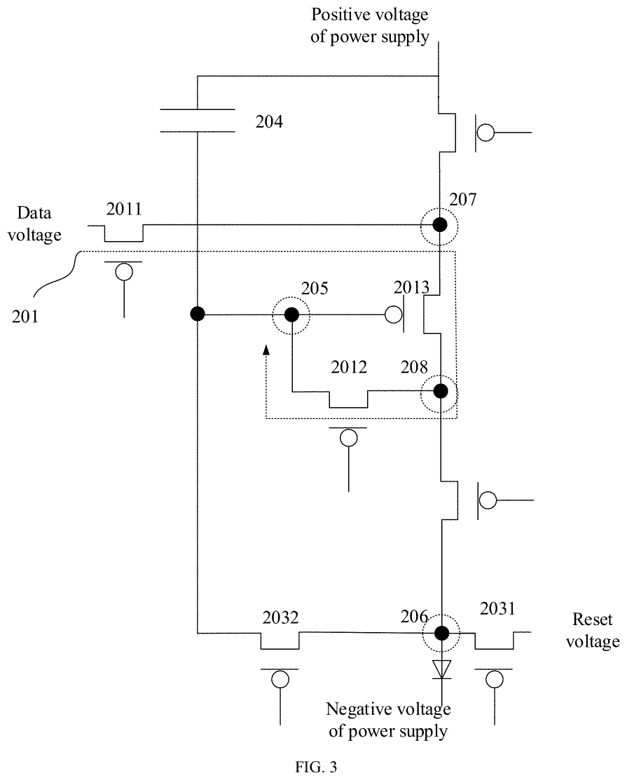

In some embodiments, referring to FIG. 3, the data writing path 201 may include a third transistor 2011, a fourth transistor 2012, and a fifth transistor 2013; a gate of the third transistor 2011 is connected to the first gating signal, a first end of the third transistor 2011 is connected to the data voltage, and a second end of the third transistor 2011 is connected to a third node 207; a gate of the fourth transistor 2012 is connected to the first gating signal, a first end of the fourth transistor 2012 is connected to a fourth node 208, and a second end of the fourth transistor 2012 is connected to the first node 205; a gate of the fifth transistor 2013 is connected to the first node 205, a first end of the fifth transistor 2013 is connected to the third node 207, and a second end of the fifth transistor 2013 is connected to the fourth node 208.

The gate of the third transistor 2011 is connected to a gating signal driver to receive the first gating signal. The first end of the third transistor 2011 is connected to the data driver to receive the data voltage. The gate of the fourth transistor 2012 is connected to the gating signal driver to receive the first gating signal.

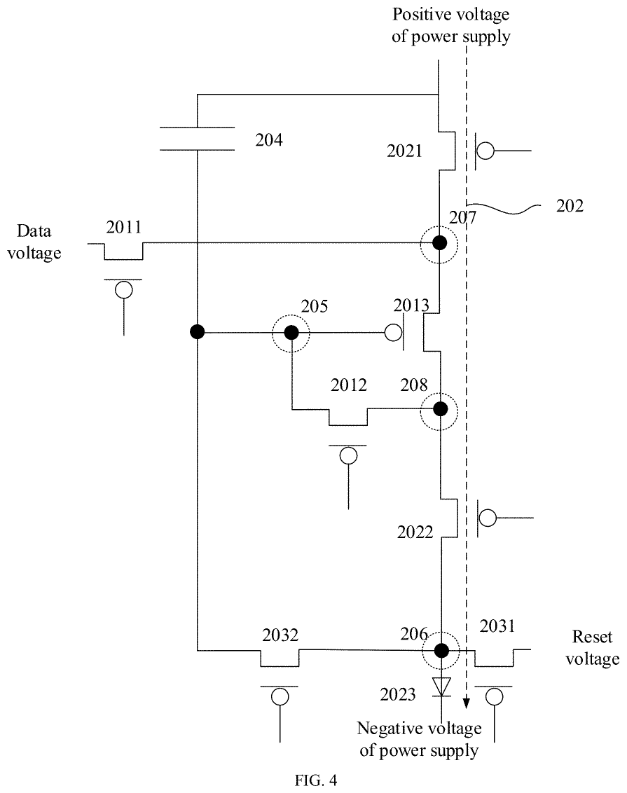

Referring to FIG. 4, the light-emitting path 202 may include a sixth transistor 2021, a seventh transistor 2022, a fifth transistor 2013, and a light-emitting diode 2023; a gate of the sixth transistor 2021 is connected to the second gating signal, a first end of the sixth transistor 2021 is connected to the positive voltage of the power supply, and a second end of the sixth transistor 2021 is connected to the third node 207; a gate of the seventh transistor 2022 is connected to the second gating signal, a first end of the seventh transistor 2022 is connected to the fourth node 208, and a second end of the seventh transistor 2022 is connected to the second node 206; a positive terminal of the light-emitting diode 2023 is connected to the second node 206, and a negative terminal of the light-emitting diode 2023 is connected to the negative voltage of the power supply; a gate of the fifth transistor 2013 is connected to the first node 205, a first end of the fifth transistor 2013 is connected to the third node 207, and a second end of the fifth transistor 2013 is connected to the fourth node 208.

The gate of the sixth transistor 2021 is connected to the gating signal driver to receive the second gating signal. The first end of the sixth transistor 2021 is connected to the power supply voltage generator to receive the positive voltage of the power supply. The gate of the seventh transistor 2022 is connected to the gating signal driver to receive the second gating signal. The negative terminal of the light-emitting diode 2023 is connected to the power supply voltage generator to receive the negative voltage of the power supply.

During a working process of the pixel driving circuit, conventionally, three phases are cyclically generated to achieve continuous light emission. The three phases are the resetting phase, the data writing phase and the light-emitting phase. In response to the pixel driving circuit being in the resetting phase, the data writing path 201 and the light-emitting path 202 are disconnected, and the reset path 203 is turned on; in response to the pixel driving circuit being in the data writing phase, the reset path 203 and the light-emitting path 202 are disconnected, and the data writing path 201 is turned on; in response to the pixel driving circuit being in the light-emitting phase, the reset path 203 and the data writing path 201 are disconnected, and the light-emitting path 202 is turned on.

The data writing path 201 is controlled by the first gating signal, the light-emitting path 202 is controlled by the second gating signal, and the reset path 203 is controlled by the third gating signal. In response to a gating signal being at a high level, a path controlled by the gating signal is disconnected, and in response to the gating signal being at a low level, the path controlled by the gating signal is turned on. In response to the pixel driving circuit being in the resetting phase, the first gating signal controls the data writing path to be disconnected, the second gating signal controls the light-emitting path to be disconnected, and the third gating signal controls the reset path to be turned on. In response to the pixel driving circuit being in the data writing phase, the third gating signal controls the reset path to be disconnected, the second gating signal controls the light-emitting path to be disconnected, and the first gating signal controls the data writing path to be turned on. In response to the pixel driving circuit being in the light-emitting phase, the third gating signal controls the reset path to be disconnected, the first gating signal controls the data writing path to be disconnected, and the second gating signal controls the light-emitting path to be turned on.

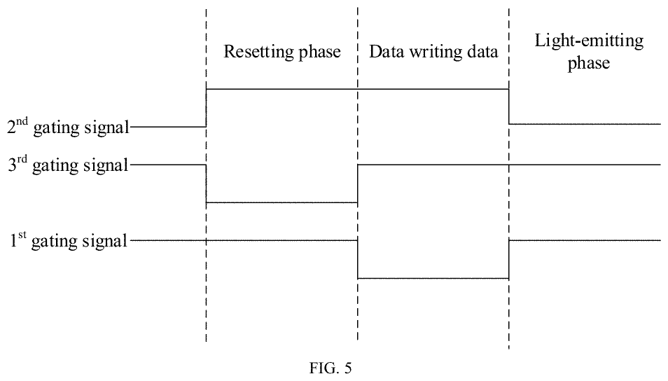

Correspondingly, referring to FIG. 5, in the resetting phase, the first gating signal is at a high level, the second gating signal is at a high level, and the third gating signal is at a low level; the reset voltage is applied to the first node 205 and the second node 206 through the reset path 203 for voltage resetting. The reset voltage is received through the reset path 203, and the first node 205 and the second node 206 are thereby voltage reset. In the data writing phase, the first gating signal is at a low level, the second gating signal is at a high level, and the third gating signal is at a high level; the data voltage is applied to the first node 205 through the data writing path 201 for data writing. The data voltage is received through the data writing path 201, and data is thereby written to the first node 205. In the light-emitting phase, the first gating signal is at a high level, the second gating signal is at a low level, and the third gating signal is at a high level; the positive voltage of the power supply and the data voltage written by the fifth transistor 2013 control the light-emitting diode 2023 to emit light. The fifth transistor 2013 is controlled by the data voltage to be turned on, and the light-emitting diode 2023 is controlled by the positive voltage of the power supply to emit light.

In some embodiments, each pixel of the display screen includes a pixel driving circuit. The display screen arranged with the pixel driving circuit at least further includes a gating signal driver and a data driver. The gating signal driver is connected to the gate of each transistor in the pixel driving circuit for controlling each transistor to be disconnected or turned on, and the data driver is connected to the first end of the third transistor 2011 for proving the data voltage to the pixel driving circuit. In addition, the gating signal driver and the data driver may be further connected to a timing controller, and the signal output of the gating signal driver and the data driver is controlled by the timing controller. The display screen may further include a power supply voltage generator for providing the positive voltage of the power supply and the negative voltage of the power supply, etc. Two interfaces of the power supply voltage generator are respectively connected to one end and the other end of the light-emitting path 202, for sending the positive voltage to one end of the light-emitting path 202 and the negative voltage to the other end of the light-emitting path 202.

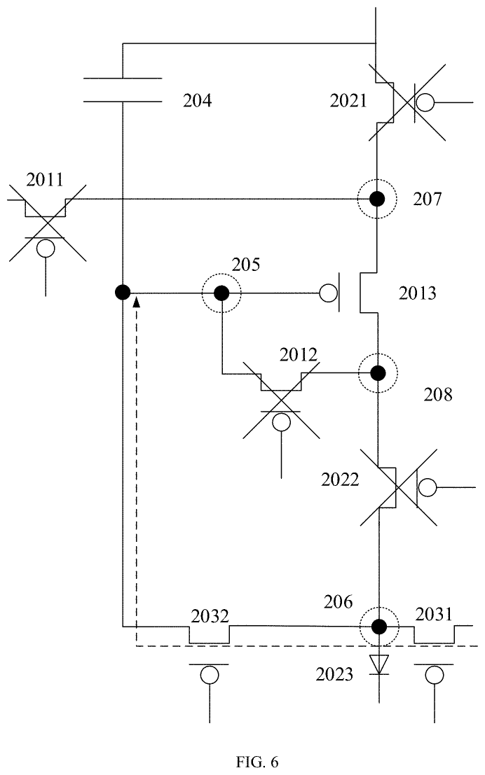

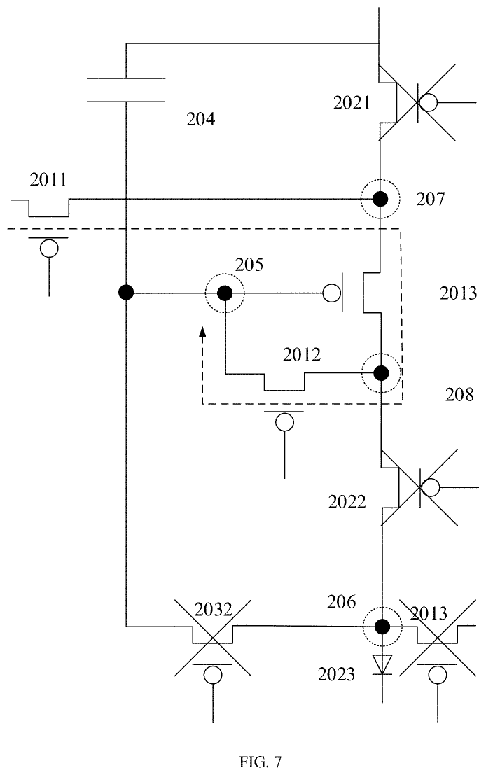

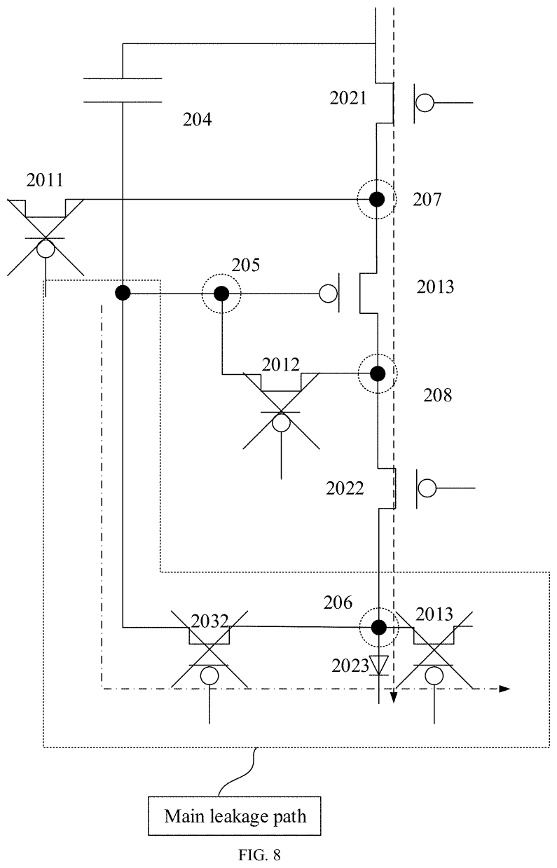

In the resetting phase, referring to FIG. 6, the first transistor 2031 and the second transistor 2032 are turned on, and other transistors are disconnected. The connected reset voltage is applied to the first node 205 and the second node 206 for voltage resetting through a path formed by the first transistor 2031 and the second transistor 2032. In the data writing phase, referring to FIG. 7, the third transistor 2011 and the fourth transistor 2012 are turned on, and other transistors are disconnected. The connected data voltage is applied to the first node 205 for data writing through a path formed by the third transistor 2011, the fifth transistor 2013, and the fourth transistor 2012. In the light-emitting phase, referring to FIG. 8, the sixth transistor 2021 and the seventh transistor 2022 are turned on, and other transistors are disconnected. the light-emitting diode 2023 is turned on through a path formed by the sixth transistor 2021, the fifth transistor 2013, and the seventh transistor 2022 to complete light emission.

The fifth transistor 2013 is a driving transistor, and the data voltage written in the data writing phase is configured to drive the fifth transistor 2013 to control a conduction degree of the fifth transistor 2013, and further to control a current passing in the light-emitting phase, thereby controlling a light-emitting brightness of the light-emitting diode 2023.

The third transistor 2011, the fourth transistor 2012, the sixth transistor 2021, the seventh transistor 2022, the first transistor 2031, the second transistor 2032, and the fifth transistor 2013 may be the same transistor or different transistors. The third transistor 2011, the fourth transistor 2012, the sixth transistor 2021, the seventh transistor 2022, the first transistor 2031, the second transistor 2032, and the fifth transistor 2013 may be at least one type of low temperature polysilicon thin film transistor, oxide semiconductor thin film transistor, or amorphous silicon thin film transistor.

The first end of each of the third transistor 2011, the fourth transistor 2012, the sixth transistor 2021, the seventh transistor 2022, the first transistor 2031, the second transistor 2032, and the fifth transistor 2013 may be a source or a drain of the corresponding transistor; the second end of each of the third transistor 2011, the fourth transistor 2012, the sixth transistor 2021, the seventh transistor 2022, the first transistor 2031, the second transistor 2032, and the fifth transistor 2013 is a different electrode from the first end of the corresponding transistor. For example, when the first end is a source, the second end is a drain; when the first end is a drain, the second end is a source. In some embodiments, the first end of the first transistor 2031 is a source, and the second end is a drain.

In addition, the third transistor 2011, the fourth transistor 2012, the sixth transistor 2021, the seventh transistor 2022, the first transistor 2031, the second transistor 2032, and the fifth transistor 2013 may be single-gate transistors or dual-gate transistors, which are not specifically limited in the embodiments of the present disclosure. In addition, the third transistor 2011, the fourth transistor 2012, the sixth transistor 2021, the seventh transistor 2022, the first transistor 2031, the second transistor 2032, and the fifth transistor 2013 may be transistors of the same gate control type or different control types, which are not specifically limited in the embodiments of the present disclosure. For example, in some embodiments, the second transistor 2032 is a dual-gated transistor.

The second transistor 2032 may be controlled by the same gating signal, or may be controlled by different gating signals, which is not specifically limited in the embodiments of the present disclosure. A disconnected dual-gated transistor is equivalent to two disconnected transistors, thereby enhancing a blocking effect when the second transistor 2032 is disconnected.

In the embodiments, by setting the second transistor 2032 as a dual-gated transistor, the blocking effect of the disconnected second transistor 2032 is enhanced, which makes the leakage of the main leakage path mitigated and reduces the leakage current of the main leakage path.

It should be noted that when the second transistor 2032 is a dual-gate transistor, other transistors may be each set as a single-gate transistor or a dual-gate transistor, which is not specifically limited in the embodiments of the present disclosure. For example, in other embodiments, the first transistor 2031 is a single-gated transistor.

In the embodiments, the second transistor 2032 is set as a dual-gated transistor, such that the second transistor 2032 may effectively block the leakage of the main leakage path and reduce the second transistor 2032. The first transistor 2031 is set as a single-gated transistor, which reduces the space occupied by the pixel driving circuit.

In the embodiments of the present disclosure, the data writing path is controlled by the first gating signal, the light-emitting path is controlled by the second gating signal, and the reset path is controlled by the third gating signal to realize the data writing, light emitting and resetting of the pixel driving circuit, thereby completing the light-emitting process of the pixel driving circuit. The first end of the first transistor is connected to the second node, the second end of the first transistor is connected to the reset voltage, and the first transistor and the second transistor are controlled to be disconnected or turned on through the third gating signal, which makes the pixel driving circuit include the first transistor and the second transistor in the main leakage path, such that the leakage current during the leakage process is the current where the voltage passes through the first transistor and the second transistor, thereby reducing the leakage current of the main leakage path. In this way, the difference of the leakage current at different frequencies is reduced, thereby reducing the difficulty of fine-tuning the correction parameters.

The working principle of the above pixel driving circuit includes the resetting phase, the data writing phase, and the light-emitting phase and will be introduced below. In the resetting phase of the pixel driving circuit, referring to FIG. 6, the data writing path and the light-emitting path in the pixel driving circuit are disconnected, and the reset path is turned on. Among them, the data writing path, the light-emitting path and the reset path are controlled to be disconnected or turned on through the gating signal input from the gate of the transistor in the corresponding path. A high-level gating signal controls a path to be disconnected, and a low-level gating signal controls a path to be turned on.

In some embodiments, the gate of the third transistor, the gate of the third transistor, the gate of the fourth transistor, the gate of the sixth transistor, the gate of the seventh transistor, the gate of the first transistor, and the gate of the second transistor corresponding to the data writing path, the light-emitting path, and the reset path are connected to different gating signals, such that the transistors may be controlled independently by different gating signals, making it possible to control the transistors more precisely.

In other embodiments, the gate of the third transistor and the gate of the fourth transistor corresponding to the data writing path are connected to the first gating signal; the gate of the sixth transistor and the gate of the seventh transistor corresponding to the light-emitting path are connected to the second gating signal; the gate of the first transistor and the gate of the second transistor corresponding to the reset path are connected to the third gating signal.

Correspondingly, referring to FIG. 5, in the resetting phase, the first gating signal is at a high level, the second gating signal is at a high level, and the third gating signal is at a low level.

In the resetting phase, the pixel driving circuit forms the reset path through the first transistor 2031 and the second transistor 2032, and the reset voltage is applied to the first node 205 and the second node 206 for voltage resetting through the reset path. Continuing to refer to FIG. 6, the second node 206 is connected between the second transistor 2032 and the first transistor 2031, and is connected to the positive terminal of the light-emitting diode. The pixel driving circuit resets the voltage of the first node through the reset voltage, and at the same time resets the positive terminal of the light-emitting diode and resets the second node.

The reset voltage is a negative voltage, and the magnitude of the reset voltage may be set as required. In the embodiments of the present disclosure, the reset voltage is not specifically limited. For example, the reset voltage may be −3V, −5V, or −12V.

In this operation, the first node and the second node in the pixel driving circuit are voltage reset by the reset voltage, such that the data voltage written when the first node is subjected to data writing is more accurate, and the voltage of the second node is not affected by a last light-emitting phase.

The completion of the resetting phase may be: a duration of the resetting phase reaches a first preset duration; or, the voltage of the first node reaches a first preset voltage value. Correspondingly, in some embodiments, the pixel driving circuit counts the duration of the reset process; in response to the duration of the reset process reaching the first preset duration, it is determined that the resetting of the first node is completed. In other embodiments, the pixel driving circuit determines the voltage of the first node, and in response to the voltage of the first node reaching the first preset voltage value, it is determined that the resetting of the first node is completed. In other embodiments, the pixel driving circuit directly controls the gating signal driver through the timing controller to complete the reset process.

In the data writing phase, referring to FIG. 7, the third transistor and the fourth transistor in the pixel driving circuit are turned on, and the sixth transistor, the seventh transistor, the first transistor, and the second transistor are disconnected. Continuing to refer to FIG. 5, during the data writing phase, the first gating signal is at a low level, the second gating signal is at a high level, and the third gating signal is at a high level. The pixel driving circuit forms the data writing path through the third transistor, the fifth transistor and the fourth transistor, and the data voltage is applied to the first node for data writing through the data writing path. The data voltage may be determined according to the intensity and duration of light emission of the current pixel. In the embodiments of the present disclosure, the magnitude of the data voltage is not specifically limited. For example, the data voltage may be 3V, 5V, or 12V.

The completion of the data writing phase may be: a duration of the data writing process reaches a second preset duration; or, the voltage of the first node reaches a second preset voltage value. Correspondingly, in some embodiments, the pixel driving circuit counts the duration of the data writing process; in response to the duration of the data writing process reaching the second preset duration, it is determined that the data writing on the first node is completed. In other embodiments, the pixel driving circuit determines the voltage of the first node, and in response to the voltage of the first node reaching the second preset voltage, it is determined that the data writing on the first node is completed. In other embodiments, the pixel driving circuit directly controls the gating signal driver through the timing controller, and controls the pixel driving circuit to complete the data writing.

In the light-emitting phase, referring to FIG. 8, the third transistor and the fourth transistor, the first transistor and the second transistor in the pixel driving circuit are disconnected, and the sixth transistor and the seventh transistor are turned on. Continuing to refer to FIG. 5, the first gating signal is at a high level, the second gating signal is at a low level, and the third gating signal is at a high level. The pixel driving circuit forms the light-emitting path through the sixth transistor, the fifth transistor, the seventh transistor and the light-emitting diode, and the positive voltage of the power supply and the data voltage written by the fifth transistor control the light-emitting diode to emit light.

In this phase, the sixth transistor and the seventh transistor are turned on by the pixel driving circuit, such that the circuit between the positive voltage of the power supply and the negative voltage of the power supply in the pixel driving circuit is turned on. In this way, a voltage between the positive and negative terminals of the light-emitting diode reaches a light-emitting voltage, thereby emitting light.

The first node is connected to the gate of the fifth transistor. The fifth transistor is a driving transistor. The data voltage written in the data voltage writing phase is configured to drive the fifth transistor, control the conduction degree of the fifth transistor, and further control the current passing in the light-emitting driving phase, thereby controlling the light-emitting brightness of the light-emitting diode.

In the light-emitting phase, a light-emitting current may be determined by Formula 1.

I=½μCox(W/L)(V_{data}−ELVDD)² (1)

Among them, I is the light-emitting current, μ and Cox are light-emitting constants, V_{data} is the data voltage written, ELVDD is the positive voltage of the power supply, W is the width of the fifth transistor, and L is the length of the fifth transistor. Therefore, (W/L) is an aspect ratio of the fifth transistor.

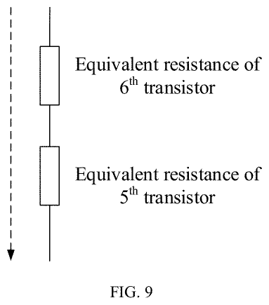

During the working process of the pixel driving circuit, due to the characteristics of transistors, when a transistor is disconnected, the current in the circuit cannot be completely blocked, resulting in leakage current in the pixel driving circuit. In the pixel driving circuit provided by the embodiments of the present disclosure, since the voltage difference between the first node and the reset voltage is the greatest, the main leakage path provided by the embodiments of the present disclosure is the path from the first node, the second transistor, the first transistor to the reset voltage. Continuing to refer to FIG. 8, the voltage that forms the leakage current in this main leakage path is the voltage difference between the first node and the reset voltage. The equivalent resistance in this path is the resistance of the first transistor and the second transistor that are disconnected. Referring to FIG. 9, FIG. 9 is an equivalent circuit diagram of the main leakage path. Therefore, the leakage current in the main leakage path may be determined by the following formula 2.

$${I}_{leakage} = \frac{{V}_{d} - {V}_{int}}{{R}_{{M}_{5}} + {R}_{{M}_{6}}} \qquad ( 2 )$$

Among them, I_{leakage} is the leakage current of the main leakage path, V_{d} is the voltage of the first node, that is, the driving voltage of the pixel driving circuit, Vᵢₙₜ is the reset voltage, R_{M}_{₅} is the equivalent resistance of the first transistor, and R_{M}_{₆} is the equivalent resistance of the second transistor.

It can be seen from the above Formula 2 that in the pixel driving circuit, the leakage current of the main leakage path is the current formed by the equivalent resistance of the first transistor and the second transistor in series. Therefore, the leakage current is small, such that the difference in leakage current at different frequencies is small, reducing the difficulty of refining the correction parameters.

It should be noted that when image display is performed on the display screen applied by the pixel driving circuit provided in the present disclosure, the resetting phase, the data writing phase, and the light-emitting phase are repeatedly executed according to a light-emitting instruction to complete the image display.

In addition, in the embodiments of the present disclosure, the process of disconnecting the third transistor and the fourth transistor by the pixel driving circuit may be: receiving the first gating signal of a first value through the gate of the third transistor and the gate of the fourth transistor; the first value is greater than a first voltage threshold of the third transistor and the fourth transistor, the first voltage threshold being a maximum voltage at which the third transistor and the fourth transistor can be turned on. The process of turning on the third transistor and the fourth transistor by the pixel driving circuit may be: the pixel driver circuit receiving the first gating signal of a second value through the gate of the third transistor and the gate of the fourth transistor; the second value is less than or equal to the first voltage threshold.

The process of disconnecting the sixth transistor and the seventh transistor by the pixel driving circuit may be: receiving the second gating signal of a third value through the gate of the sixth transistor and the gate of the seventh transistor; the third value is greater than a second voltage threshold of the sixth transistor and the seventh transistor, the second voltage threshold being a maximum voltage value at which the sixth transistor and the seventh transistor can be turned on. The process of turning on the sixth transistor and the seventh transistor by the pixel driving circuit may be: the pixel driving circuit receiving the second gating signal of a fourth value through the gate of the sixth transistor and the gate of the seventh transistor; the fourth value is less than or equal to the second voltage threshold.

The process of turning on the first transistor and the second transistor by the pixel driving circuit may be: the pixel driving circuit receiving the third gating signal of a fifth value through the gate of the first transistor and the gate of the second transistor; the fifth value is less than or equal to a third voltage threshold of the first transistor and the second transistor, the third voltage threshold being a maximum voltage value at which the sixth transistor and the seventh transistor can be turned on. The process of disconnecting the first transistor and the second transistor by the pixel driving circuit may be: the pixel driving circuit receiving the third gating signal of a sixth value through the gate of the first transistor and the gate of the second transistor; the sixth value is greater than the third voltage threshold.

The first voltage threshold may be determined according to a turn-on voltage of the third transistor and a turn-on voltage of the fourth transistor, the second voltage threshold may be determined according to a turn-on voltage of the sixth transistor and a turn-on voltage of the seventh transistor, and the third voltage threshold may be determined according to a turn-on voltage of the first transistor and a turn-on voltage of the fourth transistor. The first value, the third value, and the fifth value may be the same or different, which is not specifically limited in the embodiments of the present disclosure. For example, the first value, the third value, and the fifth value may all be 3V or 5V.

In the operation, the values of the first gating signal, the second gating signal, and the third gating signal may refer to the values corresponding to the resetting phase in FIG. 5. As shown in FIG. 5, in the resetting phase, the first gating signal is of the first value greater than the first threshold voltage, the second gating signal is of the third value greater than the second threshold voltage, and the third gating signal is of the fifth value less than or equal to the third threshold voltage.

It should be noted that the first gating signal, the second gating signal, and the third gating signal may be generated by the gating signal driver, and the gating signal driver may be connected by the timing controller, and the timing controller controls the gating signal driver to generate the gating signal.

In the embodiments of the present disclosure, the data writing path is controlled by the first gating signal, the light-emitting path is controlled by the second gating signal, and the reset path is controlled by the third gating signal to realize the data writing, light emitting and resetting of the pixel driving circuit. In order to complete the light-emitting process of the pixel driving circuit, the first end of the first transistor is connected to the second node, the second end of the first transistor is connected to the reset voltage, and the first transistor and the second transistor are controlled to be disconnected or turned on through the third gating signal, which makes the pixel driving circuit include the first transistor and the second transistor in the main leakage path, such that the leakage current during the leakage process is the current where the voltage passes through the first transistor and the second transistor, thereby reducing the leakage current of the main leakage path. In this way, the difference in the leakage current at different frequencies is reduced, thereby reducing the difficulty of fine-tuning the correction parameters.

Embodiments of the present disclosure further provide a display screen, which includes the pixel driving circuit in the embodiments of the present disclosure.

Embodiments of the present disclosure further provide a terminal, which includes the display screen in the embodiments of the present disclosure.

Those skilled in the art should be aware that, in one or more of the foregoing examples, the functions described in the embodiments of the present disclosure may be implemented by hardware, software, firmware, or any combination thereof. When implemented by software, these functions may be stored in a computer-readable medium or transmitted as one or more instructions or codes on the computer-readable medium. The computer-readable medium includes a computer storage medium and a communication medium, where the communication medium includes any medium that facilitates the transfer of a computer program from one place to another. The storage medium may be any available medium that may be accessed by a general-purpose or special-purpose computer.

The above are only some embodiments of the present disclosure and are not intended to limit the present disclosure. Any modification, equivalent replacement, improvement, etc. made within the spirit and principle of the present disclosure shall be included within the scope of the present disclosure.

What is claimed is:

1. A pixel driving circuit, comprising:
a data writing path, a light-emitting path, a reset path, and a capacitor;
wherein an end of the data writing path is configured to receive a data voltage, another end of the data writing path is connected to a first node; an end of the light-emitting path is configured to receive a positive voltage of a power supply, and another end of the light-emitting path is configured to receive a negative voltage of the power supply;
wherein the reset path comprises a first transistor and a second transistor, a first end of the first transistor being connected to a second node, a second end of the first transistor being configured to receive a reset voltage, a first end of the second transistor being connected to the first node, and a second end of the second transistor being connected to the second node;
wherein an end of the capacitor is connected to the positive voltage of the power supply, and another end of the capacitor is connected to the first node;
wherein the data writing path is controlled by a first gating signal, the light-emitting path is controlled by a second gating signal, and the reset path is controlled by a third gating signal, such that the pixel driving circuit is controlled to be selectively in a resetting phase, a light-emitting phase, or a data writing phase.

2. The pixel driving circuit according to claim 1, wherein the data writing path comprises a third transistor, a fourth transistor, and a fifth transistor;
a gate of the third transistor is configured to receive the first gating signal, a first end of the third transistor is configured to receive the data voltage, and a second end of the third transistor is connected to a third node;
a gate of the fourth transistor is configured to receive the first gating signal, a first end of the fourth transistor is connected to a fourth node, and a second end of the fourth transistor is connected to the first node;
a gate of the fifth transistor is connected to the first node, a first end of the fifth transistor is connected to the third node, and a second end of the fifth transistor is connected to the fourth node.

3. The pixel driving circuit according to claim 1, wherein the light-emitting path comprises a sixth transistor, a seventh transistor, a fifth transistor, and a light-emitting diode;
a gate of the sixth transistor is configured to receive the second gating signal, a first end of the sixth transistor is configured to receive the positive voltage of the power supply, and a second end of the sixth transistor is connected to the third node;
a gate of the seventh transistor is configured to receive the second gating signal, a first end of the seventh transistor is connected to a fourth node, and a second end of the seventh transistor is connected to the second node;
a positive terminal of the light-emitting diode is connected to the second node, and a negative terminal of the light-emitting diode is configured to receive the negative voltage of the power supply;
a gate of the fifth transistor is connected to the first node, a first end of the fifth transistor is connected to the third node, and a second end of the fifth transistor is connected to the fourth node.

4. The pixel driving circuit according to claim 1, wherein a gate of the first transistor and a gate of the second transistor are both configured to receive the third gating signal.

5. The pixel driving circuit according to claim 1, wherein in response to the pixel driving circuit being in the resetting phase, the first gating signal controls the data writing path to be disconnected, the second gating signal controls the light-emitting path to be disconnected, and the third gating signal controls the reset path to be turned on.

6. The pixel driving circuit according to claim 1, wherein in response to the pixel driving circuit being in the data writing phase, the third gating signal controls the reset path to be disconnected, the second gating signal controls the light-emitting path to be disconnected, and the first gating signal controls the data writing path to be turned on.

7. The pixel driving circuit according to claim 2, wherein in response to the pixel driving circuit being in the light-emitting phase, the third gating signal controls the reset path to be disconnected, the first gating signal controls the data writing path to be disconnected, and the second gating signal controls the light-emitting path to be turned on.

8. The pixel driving circuit according to claim 5, wherein in the resetting phase, the first gating signal is at a high level, the second gating signal is at a high level, and the third gating signal is at a low level;
wherein the reset voltage is received through the reset path, and the first node and the second node are voltage reset.

9. The pixel driving circuit according to claim 6, wherein in the data writing phase, the first gating signal is at a low level, the second gating signal is at a high level, and the third gating signal is at a high level;
wherein the data voltage is received through the data writing path, and data is written to the first node.

10. The pixel driving circuit according to claim 7, wherein in the light-emitting phase, the first gating signal is at a high level, the second gating signal is at a low level, and the third gating signal is at a high level;
wherein the fifth transistor is controlled by the data voltage to be turned on, and the light-emitting diode is controlled by the positive voltage of the power supply to emit light.

11. The pixel driving circuit according to claim 1, wherein the second transistor is a dual-gated transistor.

12. The pixel driving circuit according to claim 1, further comprising a gating signal driver;
wherein the gating signal driver is connected to a gate of the first transistor and a gate of the second transistor;
wherein the gating signal driver is configured to send the third gating signal to the first transistor and the second transistor to control the first transistor and the second transistor to be disconnected or turned on.

13. The pixel driving circuit according to claim 12, further comprising a timing controller;
wherein the timing controller is connected to the gating signal driver;
wherein the timing controller is configured to control a signal output of the gating signal driver.

14. The pixel driving circuit according to claim 1, wherein the reset voltage is of any voltage value among −3V, −5V, or −12V.

15. The pixel driving circuit according to claim 1, wherein during the resetting phase, data writing phase and light-emitting phase occurring cyclically, completion of the resetting phase comprises: a duration of the resetting phase reaching a first preset duration; or, a voltage of the first node reaching a first preset voltage value.

16. The pixel driving circuit according to claim 1, wherein the first transistor and the second transistor are of at least one type of: a low temperature polysilicon thin film transistor, an oxide semiconductor thin film transistor, or an amorphous silicon thin film transistor.

17. The pixel driving circuit according to claim 1, further comprising a power supply voltage generator;
wherein an interface of the power supply voltage generator is connected to an end of the light-emitting path, and another interface of the power supply voltage generator is connected to another end of the light-emitting path, for sending the positive voltage to the end of the light-emitting path and the negative voltage to the another end of the light-emitting path.

18. The pixel driving circuit according to claim 1, wherein a leakage path of the pixel drive circuit is a path including the first node, the second transistor, and the first transistor.

19. A display screen, comprising:
a pixel driving circuit;
wherein the pixel driving circuit comprises a data writing path, a light-emitting path, a reset path, and a capacitor;
wherein an end of the data writing path is configured to receive a data voltage, another end of the data writing path is connected to a first node; an end of the light-emitting path is configured to receive a positive voltage of a power supply, and another end of the light-emitting path is configured to receive a negative voltage of the power supply;
wherein the reset path comprises a first transistor and a second transistor, a first end of the first transistor being connected to a second node, a second end of the first transistor being configured to receive a reset voltage, a first end of the second transistor being connected to the first node, and a second end of the second transistor being connected to the second node;
wherein an end of the capacitor is connected to the positive voltage of the power supply, and another end of the capacitor is connected to the first node;
wherein the data writing path is controlled by a first gating signal, the light-emitting path is controlled by a second gating signal, and the reset path is controlled by a third gating signal, such that the pixel driving circuit is controlled to be selectively in a resetting phase, a light-emitting phase, or a data writing phase.

20. A terminal, comprising:
a display screen comprising a pixel driving circuit;
wherein the pixel driving circuit comprises a data writing path, a light-emitting path, a reset path, and a capacitor;
wherein an end of the data writing path is configured to receive a data voltage, another end of the data writing path is connected to a first node; an end of the light-emitting path is configured to receive a positive voltage of a power supply, and another end of the light-emitting path is configured to receive a negative voltage of the power supply;
wherein the reset path comprises a first transistor and a second transistor, a first end of the first transistor being connected to a second node, a second end of the first transistor being configured to receive a reset voltage, a first end of the second transistor being connected to the first node, and a second end of the second transistor being connected to the second node;
wherein an end of the capacitor is connected to the positive voltage of the power supply, and another end of the capacitor is connected to the first node;
wherein the data writing path is controlled by a first gating signal, the light-emitting path is controlled by a second gating signal, and the reset path is controlled by a third gating signal, such that the pixel driving circuit is controlled to be selectively in a resetting phase, a light-emitting phase, or a data writing phase.
